(19) United States
(12) Patent Application Publication
(10) Pub. No.: US 2017/0330112 A1
(43) Pub. Date: Nov. 16, 2017

(54) TRAVEL DEMAND INFERENCE FOR PUBLIC TRANSPORTATION SIMULATION

(71) Applicant: Conduent Business Services, LLC, Dallas, TX (US)

(72) Inventor: Boris Chidlovskii, Meylan (FR)

(73) Assignee: Conduent Business Services, LLC, Dallas, TX (US)

(21) Appl. No.: 15/151,773

(22) Filed: May 11, 2016

(51) Int. Cl. G06Q 10/02; G01C 21/26; G06Q 30/02; G06Q 50/30

(52) U.S. Cl. CPC G06Q 10/025; G06Q 30/0202; G01C 21/26; G06Q 50/30

(57) ABSTRACT

A method for estimating travel demand in a transportation network includes receiving a dataset of trips. The trips were taken in the transportation network and are each represented by an origin-destination pair and a departure time. A trip can include a sequence of legs. Each trip is described by a vector of modalities. For trips that include the sequence of legs, boarding and alighting stops are estimated. An empirical trip distribution is generated for each modality for given origin-destination stops. The empirical trip distribution is fitted to a specific family of probability distributions. At least one of the generating the empirical trip distribution for a given modality and the fitting the empirical trip distribution to the probability distributions is performed with a processor.

### BACKGROUND

The present disclosure relates to trip simulation in a transportation network. The disclosure finds application in public transportation systems, particularly regarding the simulation of passenger behavior to estimate demand, but it is also amenable to other modes of transport.

A public transportation network is defined by, inter alia, specified modes of transportation (bus, rapids, and ferries, etc.), stop locations, routes that serve the stops, change points, and route schedules. Passenger behavior can be observed by transactions, such as, for example, ticket-based trips where passengers swipe or scan a fare card upon entering or exiting a vehicle.

This information can be collected by the public transportation system to build a dataset used to create a simulation of the public transportation network. The simulation of public transportation systems plays an important role in urban transportation management and planning. The main goal of any public transportation simulation is to reproduce the daily traffic flow as accurately as possible. The simulation enables a public transportation system to understand the different components of the existing system—such as passenger behavior—and to test new scenarios for improving its efficiency.

Existing simulators are able to reconstruct, at a certain quality, a set of trips taken by passengers who traveled in a given transportation network. Besides the aforementioned information, any existing public transportation simulation can also require vehicle characteristics (s.a., capacity, maximum speed, and desired speed, etc.), driver characteristics, and behavior data. Travel demand, in the form of temporal O-D (origin-destination) matrices based on departure times T can be inferred or modeled for the simulation as well as a trip generation model (i.e., “trip planner”), which assigns passenger trips to routes, stops and change points. Depending on the type of installation, such as where ticket validation data is available, the temporal O-D matrices are extracted by assigning each passenger trip to a corresponding origin-destination pair (o, d). Then, the trip planner can be used for finding an optimal route assignment. In other words, given an estimated number of trips N, sample ODT N times q=(o, d, t)˜ODT, use the trip planner to route (q). The observed passenger flow data can be used to validate the developed simulation model.

One problem with the existing approach is that it aggregates too much sample ODT data, in part for a set of short trips, thus unveiling certain limitations in accurately simulating the transit trips. For example, in an entry-only ticket validation operation, it can be difficult to track passengers during transfers. Particularly, where a passenger disappears between two sequential validations, the existing simulator can only estimate to a mathematical probability the passenger behavior between stop A, when the passenger validated the last time, and stop B, when the passenger validates again.

Furthermore, the existing approach generates an important divergence from the observed trips due to a number of factors. In other words, one challenge with existing simulators is that people do not necessarily travel along the same route—s.a., the shortest or fastest route—estimated by the simulation. Therefore, a system and method is desired for more accurately estimating passenger behavior and trips taken in a transportation network and predicting future transportation needs based on such behavior. This means that a system is desired which can better estimate the passenger behavior instead of inferring such passenger behavior between two stops where a passenger track disappears.

### BRIEF DESCRIPTION

One embodiment of the disclosure relates to a method for estimating travel demand in a transportation network. According to the method, a dataset of trips is received. The trips were taken in the transportation network and are each represented by an origin-destination pair and a departure time. A trip can include a sequence of legs. Each trip is described by a vector of modalities. For trips that include the sequence of legs, boarding and alighting stops are estimated. An empirical trip distribution is generated for each modality for given origin-destination stops. The empirical trip distribution is fitted to a specific family of probability distributions. At least one of the generating the empirical trip distribution for a given modality and the fitting the empirical trip distribution to the probability distributions is performed with a processor.

Another embodiment of the disclosure is directed to a system for estimating travel demand in a transportation network. The system includes a computer programmed to perform a method for estimating the travel demand. The computer is operative to receive a dataset of trips taken in the transportation network each represented by an origin-destination pair and a departure time. A trip can include a sequence of legs. The computer is further operative to describe each trip by a vector of modalities. For trips that include the sequence of legs, the computer is operative to further estimate boarding and alighting stops. The computer is operative to generate an empirical trip distribution for each modality for given origin-destination stops. The computer is operative to fit the empirical trip distribution to a specific family of probability distributions.

### BRIEF DESCRIPTION OF THE DRAWINGS

FIG. 1 is a schematic showing a computer-implemented system for generating a trip simulation.

FIG. 2 is a flowchart showing a method for estimating trips in a transportation network.

FIG. 3A shows stops in an illustrative transportation network, where the equivalence involves a segment of one street route (or line).

FIG. 3B shows stops in an illustrative transportation network, where the equivalence involves a common fragment of multiple streets (or lines) along the route.

FIG. 4 is a flowchart illustrating a method 400 for generating stop equivalence classes.

FIG. 5 shows trip uncertainty plotted for all origin-destination pairs in an illustrative dataset of trips taken in a sample transportation network.

FIG. 6A shows an alighting probabilistic inference generated for a tight transfer from a first service to a second service.

FIG. 6B shows the alighting probabilistic inference generated for a loose transfer from the first service to the second service.

FIG. 7A shows an illustrative trip angle(s) for a sample uni-goal or roundtrip where a spatial modality is determined by measuring a trip ratio of a distance connecting the origin to the destination to a sum of leg distances.

FIG. 7B shows an illustrative trip angles for a sample trip including multiple legs where a spatial modality is determined by measuring a trip ratio of a distance connecting the origin to the destination to a sum of leg distances.

FIG. 8A shows an illustrative empirical trip angle distribution for an illustrative dataset of trips taken in a transportation network.

FIG. 8B shows an illustrative Beta distribution for the same trips also represented by the distribution of FIG. 8A.

FIG. 9 shows the empirical trip angle distribution segmented by time in the unit of hours.

FIG. 10A shows stops in a transportation network, which can be color coded to each correspond with the shape of the different Beta distribtinons shown in FIG. 10B.

FIG. 10B show the different Beta distributions each corresponding to a color on the graph of FIG. 10A.

FIG. 11 shows an empirical distribution and a Beta distribution for an example dataset.

FIG. 12 shows the empirical trip angle distribution of the expected waiting time in the example dataset

### DETAILED DESCRIPTION

The present disclosure relates to trip simulation in a transportation network in the context of a public transport simulation, for illustrative purposes. The disclosure estimates travel demand by simulating passenger behavior from a collection of passenger trips forming a dataset. However, the disclosure herein is amenable to other travel networks and there is no limit to the type traveler.

The present disclosure proposes to model a trip distribution with a Beta function distribution. The disclosure designs specific features xᵢ (parameters of modalities) that can be inferred from historical trip data. In particular, the ratio of trip distance to the trip length for one transaction is disclosed as a measure of how far a trip deviates from a theoretically direct connection between an origin stop and a destination spot.

As used herein, a trip is represented by an origin-destination pair and a departure time, and a trip can include a sequence of legs. A uni-goal trip, as used herein, is a trip where the passenger travels in more or less the same direction, without diverging greatly from that direction of travel. A uni-goal trip may include a round trip. A multi-goal trip, as used herein, is a trip where the passenger makes at least one change during the trip.

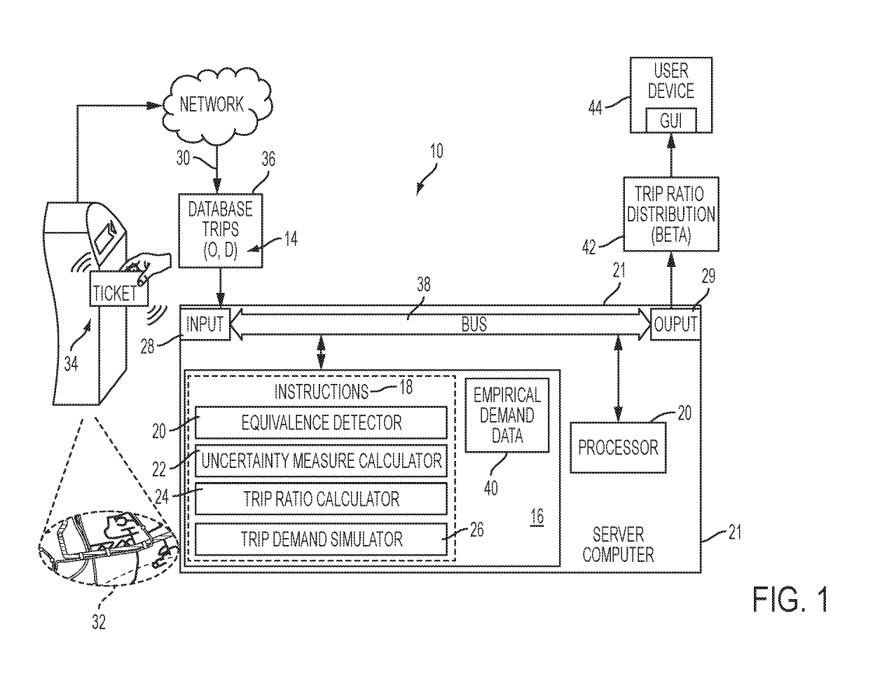

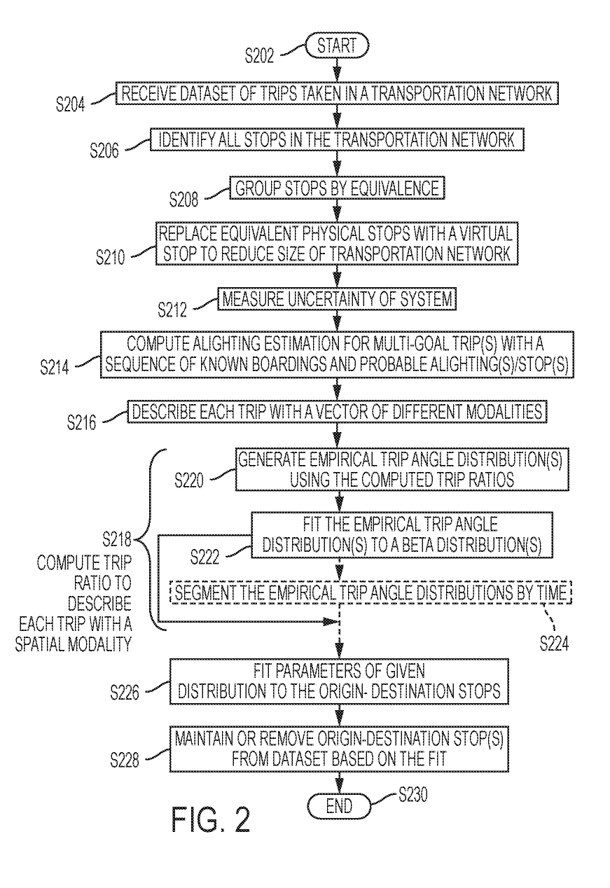

With reference to FIG. 1, a computer-implemented system 10 for generating a trip simulation using observed input data, such as passenger trip data 14, is shown. The system 10 includes memory 16, which stores instructions 18 for performing the method illustrated in FIG. 2, and a processor 20 in communication with the memory for executing the instructions. The system 10 may include one or more computing devices 22, such as the illustrated server computer. One or more input/output devices 28, 29 allow the system to communicate with external devices, such as a video capture device 28, or other source of an image, via wired or wireless links 30, such as a LAN or WAN, such as the Internet. In one embodiment, the server computer 22 receives a dataset of trips 14 taken from a transportation network 32. In one embodiment, this dataset can be built from or collected from ticketing transactions 34 in the transportation network 32 and stored in a database 36. The ticketing transactions 34 can include, as just one nonlimiting example, the departure times collected when a passenger scans its ticket 34a at a turnstyle scanner 34b, a bus (or vehicle scanner) or collected by any other mechanism used to validate and verify passage. Similarly, in transportation networks that include a second, different scanner to at the arrival stop, the arrival information can be collected. There is no limitation made herein to the methods used by the transportation network to validate information regarding how passengers are traveling in the public transportation network. The transportation network 32 supplies the trips information 14 to the system 10 for processing. Hardware components 16, 20, 28, 29 of the system communicate via a data/control bus 36.

The illustrated instructions 18 include a stop equivalence detector 20, an uncertainty measure calculator 22, a trip ratio calculator 24, and a trip simulator 26.

The stop equivalence detector 20 identifies all stops in the transportation network; groups equivalent stops in a cluster; merges equivalent stops into classes; and reduces the number of stops in the transportation network based on the classes. Simply summarized, the stop equivalence detector 20 identifies an equivalence relationship between neighboring stops in the transportation network that share a set of change points achievable form the stops. The trip ratio calculator 24 determines a spatial modality by measuring a trip ratio of a distance connecting the origin a and the destination of a trip to a sum of leg distances for each trip; and generates an empirical trip distribution for the spatial modality. The uncertainty measure calculator 22 measures uncertainty of one trip over another in the transportation network using the empirical trip distribution 40. The trip simulator 26 fits the empirical trip distribution 40 to Beta distributions 42 split by at least a second modality, such as time, indicative of passenger behavior at the different stops. For example, the empirical data can predict that passenger(s) would be traveling from a specific origin to a specific destination, and the beta function parameter generates the type (route/path) of trip that the passenger(s) would take.

The predicted passenger behavior information, in the form of the Beta distributions 40, equivalence stops and classes, trips information 14, and/or other information based thereon is output by the system 10 to a removed device, such as user device 44.

The computer system 10 may include one or more computing devices 22, such as a PC, such as a desktop, a laptop, palmtop computer, portable digital assistant (PDA), server computer, cellular telephone, tablet computer, pager, trip validation device, such as a ticket scanner 34b, combinations thereof, or other computing device capable of executing the instructions for performing the exemplary method.

The memory 16 may represent any type of non-transitory computer readable medium such as random access memory (RAM), read only memory (ROM), magnetic disk or tape, optical disk, flash memory, or holographic memory. In one embodiment, the memory 16 comprises a combination of a random access memory and read only memory. In some embodiments, the processor and memory 16 may be combined in a single chip. Memory 16 stores instructions for performing the exemplary method as well as the processed data 12, 40.

The network interface 28, 29 allows the computer to communicate with other devices via a computer network, such as a local area network (LAN) or wide area network (WAN), or the internet, and may comprise a modulator/demodulator (MODEM), a router, a cable, and/or Ethernet port.

The digital processor device 20 can be variously embodied, such as by a single-core processor, a dual-core processor (or more generally by a multiple-core processor), a digital processor and cooperating math coprocessor, a digital controller, or the like. The digital processor 20, in addition to executing instructions 18 may also control the operation of the computer 22.

The term “software,” as used herein, is intended to encompass any collection or set of instructions executable by a computer or other digital system so a to configure the computer or other digital system to perform he task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

FIG. 2 is a flowchart illustrating a method 200 for estimating trips in a transportation network. The method starts at S202. At S204, the system receives a dataset of trips taken in a transportation network-of-interests where each trip is represented by an origin-destination (O,D) pair and a departure time. This dataset can be acquired from a database 14 or storage in communication with the system. The dataset includes a sample or all trips taken by passengers of the transportation network during a given time frame. The transportation network is defined by a number of stop locations. Therefore, a given origin and a given destination are contemplated to correspond with at least one of the stops in the transportation network.

One aim of the system is to improve a trip simulation through a better estimation of the data which impact the simulation, such as the route or way a passenger travels. The conventional simulation approach infers passenger behavior between stops—which are usually in close proximity—during trips that are multiple legs where the passenger's behavior becomes unknown due to the absence of that passenger appearing at a change (i.e., a “change stop”) through the transportation network. A conventional dataset observes the history of what happens in a system, and not necessarily the way passengers travels in the system. Therefore, the conventional approach treats this ambiguity by inferring—i.e., assigning an equal or low probability to—the passenger's likely behavior between the known stops.

Because a transportation network can include thousands of stops, a first step in the method is to group the stops in a way that can increase the quality of prediction. At S206, the system identifies all stops in the transportation network. The equivalence detector 20 groups stops that are equivalent from the point of traveling at S208. That is, the physical/actual stops that behave the same in the transportation network are grouped as one virtual stop. This operation reduces the number of stops in the transportation network. In other words, the number of equivalent physical stops is replaced by a smaller number of virtual stops, which enables a faster compilation of the dataset and a more accurate prediction. The reason the prediction becomes more accurate is because the system no longer needs to infer information (such as, passenger behavior) between multiple stops which otherwise cannot be distinguished in the conventional approach.

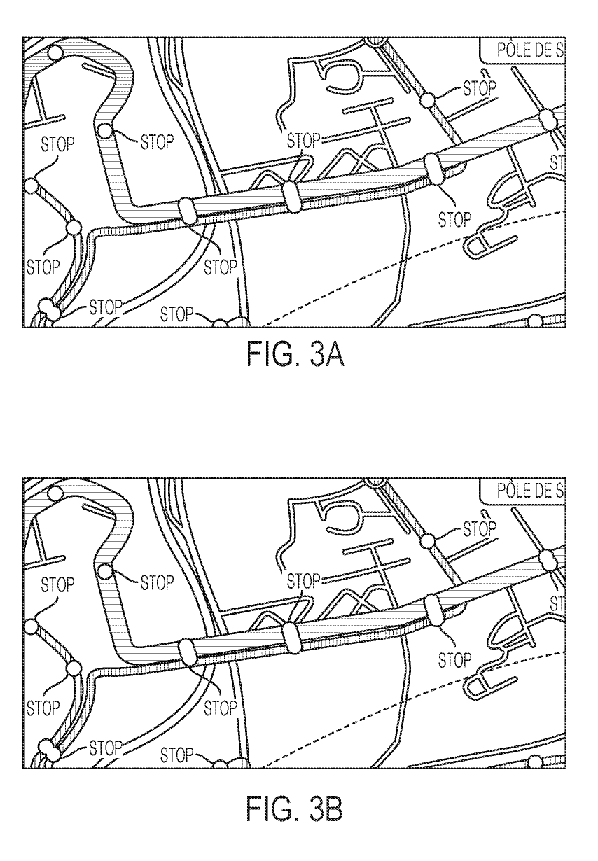

To group the stops, the equivalence detector 20 identifies an equivalence relationship between neighboring stops in the transportation network. In one embodiment, the criterion to detect equivalence is whether the stops can perform the same way. The stops that behave the same are grouped into clusters. FIG. 3A shows stops in an illustrative transportation network, where the equivalence involves a segment of one street route (or line). FIG. 3B shows stops in an illustrative transportation network, where the equivalence involves a common fragment of multiple streets (or lines) along the route.

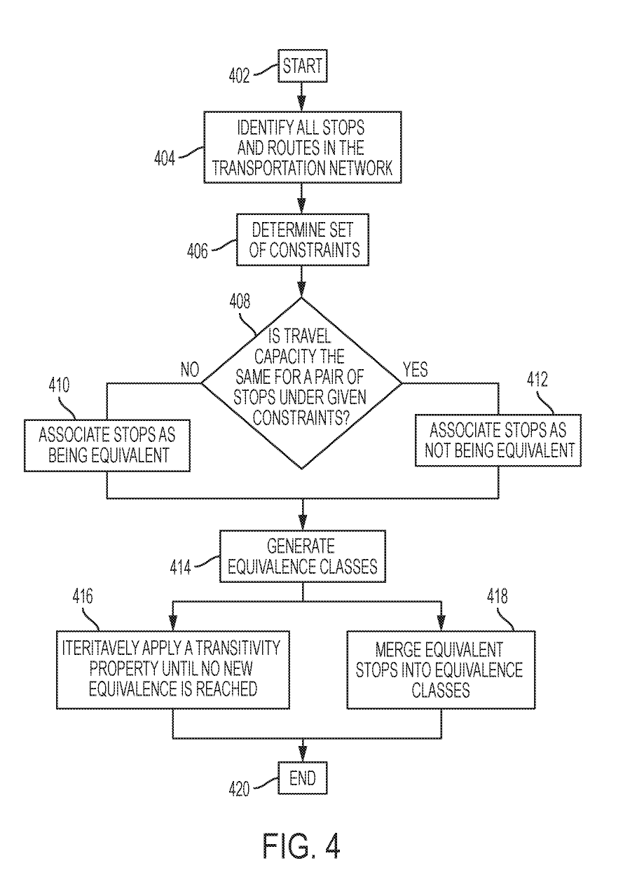

FIG. 4 is a flowchart illustrating a method 400 for generating stop equivalence classes. The method starts at S402. At S404, the equivalence detector 20 identifies all physical stops and routes in the transportation network. The equivalence detector 20 determines a set of constraints U at S406. Mainly, the traveling capacity Tof a stop s is a set of trips that a passenger can take from s, under a set of constraints U. The set of constraints U controls the possible trip space. For example, a constraint(s) can limit the number of possible changes to a predetermined number. Another constraint(s) can limit a maximum walking distance to a predetermined distance (s.a., e.g., a predefined number of meters). These constraints can be provided to the system as user input via a GUI in communication with the server computer 22 before or during the simulation.

To establish pair-wise stop equivalence, the equivalence detector 20 examines a pair two stops s₁ and s₂, which can or may not be neighboring stops. In the contemplated embodiment, a pair includes a given stop s in the transportation network the next stop next(s) along one route. At S408, for each pair of stops in the transportation network (sₙ, next(s)), the equivalence detector 20 determines if the stops realize the same trip for passengers under the given constraints U, T(s₁; U)=T(s₂; U). In other words, can a passenger achieve the same travel outcome from both stops in the pair being processed? In simpler terms, do the two stops (sₙ, next(s)) realize the same travel offers or traveling capacity under the given constraints? In one embodiment, for example, for any constraint set U, the equivalence of two stops can be reduced to the equivalence of change points achievable from the stops during a first leg, i.e., equal(s₁, s₂; U)≡[achieve(s₁; U)=achieve(s₂; U)]. Therefore, in response to the traveling capacity (or travel offers) being the same for both stops in a pair T(s₁; U)≠T(s₂; U) (YES at S408), the equivalence detector 20 associates the pair of stops as being equivalent equal(s₁, s₂; U) at S410. In response to the traveling capacity (or travel offer) not being the same for both stops in a pair T(s₁; U)≠T(s₂; U) (NO at S408), the equivalence detector associates the stops as not being equivalent at S412.

A pair of equal stops forms oriented arcs in a stop graph. Continuing with FIG. 4, the equivalence detector 20 uses a transitivity property to generate equivalence classes at S414. To detect the equivalence classes, the equivalence detector 20 identifies an equivalence relationship between pairs of equal stops, where each pair includes a same stop. In other words, the determination is made between three stops (s₁, s₂, s₃) that make up two pairs of equal stops. For each set of equal stops equal(s₁, s₂; U) and equal (s₂, s₃; U), the equivalence detector 20 applies a transitivity property at S416. The equivalence detector 20 iteratively applies the transitivity property, associating the two stops that different in each pair as equivalents equal (s₁, s₃; U), until no new equivalence is computed. In other words, the equivalence detector 20 finds the transitive closure of a relation equal. In one contemplated embodiment, the system can apply a Floyd-Warshall algorithm, which requires O(n³) time and O(n²) space, where n is the number of stops. Next, the equivalence detector 20 merges equivalent stops in the transportation network into equivalence classes at S418.

In summary, the equivalence detector 20 first identifies equivalence relationships between neighboring stops along a route in a transpiration network, where the equivalence is verified by the set of change points achievable from the stops. Then, the system applies the transitivity property to obtain the stop equivalence classes. In one embodiment, the algorithm disclosed below can be performed by the system to determine the equivalence classes as illustrated in FIG. 4.

Algorithm 1 Stop equivalence classes.

| Require: Network of stops and routes | |
|---|---|
| Require: Constraint set U | |
| 1: | Step 1. Establish pair-wise stop equivalence |
| 2: | for each pair (s,next(s)) in the network do |
| 3: | if achieve(s; U) = achieve(next(s); U) then |
| 4: | set equal(s, next(s)) |
| 5: | end if |
| 6: | end for |
| 7: | Step 2. Use transitivity closure to get equivalence classes |
| 8: | repeat |
| 9: | for any triples(s₁, s₂, s₃) do |
| 10: | if equal (s₁, s₂) and equal (s₂,s₃) then |
| 11: | set equal(s₁,s₃) |
| 12: | end if |
| 13: | end for |
| 14: | until No new equivalence |
| 15: | return Set of stop equivalence classes |

The method ends at S420.

Returning to FIG. 2, the equivalent physical stops equal(s₁, s₂; are replaced with a virtual stop in the transportation network at S210. Grouping stops by their equivalence classes allows the system to reduce the number of stops and trips to consider. It makes the origin-destination matrices denser.

Next, the uncertainty measure calculator 22 measures the uncertainty of one route over a different route from origin o and destination d. Mainly, the uncertainty measure calculator 22 is distinguishing between multi-goal versus uni-goal trips. As mentioned, supra, a multi-goal trip is a trip where the passenger makes at least one change during the trip. The uncertainty stems from observed behavior that is not measurable. Particularly, in one example, a passenger might validate a transaction (for example, board a vehicle) at one stop and disappear for a duration. It isn't uncommon for passengers to use a ticket that is valid for a predetermined amount of time, such as, for example, one hour, to travel multiple times. Should a passenger initially enter the transportation network at an origin stop, reach a destination (that cannot be measured via a transaction), do something for a short period, such as shop, grab coffee, etc., and reboard an opposite-bound vehicle to return with one ticket, the origin and destination stops are the same. Such a trip is treated herein as a multi-goal trip because the passenger spent some time at an unknown destination, for whatever the passenger's purpose, that is removed from the shared origin/destination stop. This ambiguity creates uncertainty, which the present system aims to reconcile.

For a trip t given by origin-destination pair t=(o, d), the uncertainty measure calculator 22 measures the uncertainty using the Kullback-Leibler divergence KL(q//pᵤ) of the trip distribution q from the uniform trip distribution pᵤ. The higher the KL values, the lower uncertainty and a clear domination of one trip over others. In other words, the KL value is inversely proportional to a level of uncertainty and is directly proportional to the strength of one trip over the other.

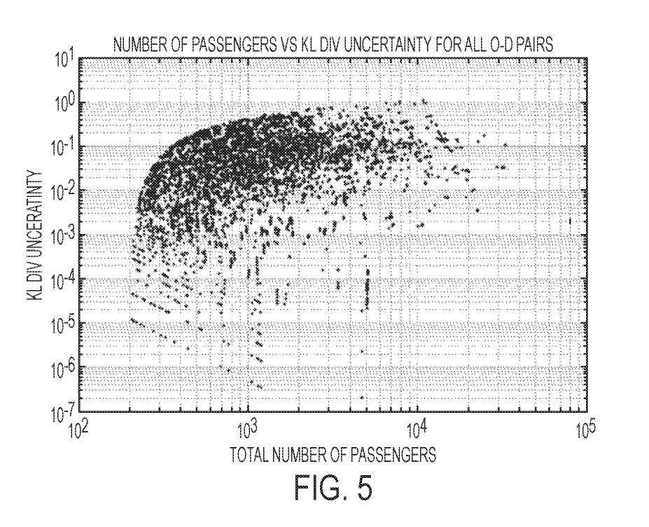

FIG. 5 shows trip uncertainty plotted for all origin-destination pairs in an illustrative dataset of trips taken in a sample transportation network. The illustrative dataset includes approximately 127,000 trips each represented by origin-destination (o, d) pairs. FIG. 5 plots the KL divergence values for the destination (o, d) pairs using a log-log scale. The high density zone shown in the plot suggests that a large portion of the pairs is dominated by two or more different routes/paths of high frequency.

The uncertainty measure calculator 22 measures the uncertainty of the entire public transportation system by the expectation of Kullback-Leibner divergence over a trip variable. Given the instantiation of as origin-destination pairs (o, d) in the transportation network and the empirical trip distribution, the network uncertainty can be estimated using the equation:

Uncertainty= [symbol] _{ξ}[KL(ξ)]=Σ_{ξ=(o,d)εOD} P(ξ)KL(q_{ξ}∥pᵤ) (1)

In this manner, the system can reduce or eliminate the source of uncertainty linked to multiple possible changes between lines.

Returning to FIG. 2, for further processing, the system 100 distinguishes between cases when a trip appears to be uni-goal from cases where it does not. For the latter—i.e., multi-goal trips with a sequence of known boardings and probable alighting stops—the trip ratio calculator 24 computes a probabilistic alighting estimation at S214.

This estimate corresponds to a probability for a given stop to be an alighting for a given boarding. In an entry-exit public transportation system, an individual passenger trip J represents a sequence of public transportation services its takes and changes between them. The passenger trip J is a sequence of legs SJ={l₁, . . . , lₙ}, n≧1, where any leg lᵢ is a tuple (sᵢ, bᵢ, aᵢ, t^{b}ᵢ, t^{a}ᵢ), where sᵢ is a service identifier (a bus number, for example); bᵢ and aᵢ are boarding and alighting stop identifiers; and t^{b}ᵢ, t^{a}ᵢ are boarding and alighting timestamps. A trip is direct if n=1, or transit otherwise.

In the entry-only systems, only passenger boardings are recorded while the alightings are a subject of inference when reconstructing the passenger trips. In this system, the trip is a sequence Su={l₁, . . . , lₙ}, n≧1, where a leg lᵢ is a tuple {sᵢ, bᵢ, t^{b}ᵢ, Σ(aᵢ), {t^{a}ᵢ}}, where bᵢ is the boarding stop; t^{b}ᵢ is the boarding timestamp; Σ(aᵢ) and {t^{b}ᵢ}) are alighting stop distribution and their timestamps, respectively.

However, in absence of annotated trips, a parametric unsupervised learning can be used for distinguishing between trips which appear to have a unique path between an origin stop O and destination stop D and all other trips (e.g., round trips, and lengthy change times, etc.). Each trip t is described with a vector x(t)=(x₁, . . . , xₖ) of different modalities (spatial, temporal, personal, etc.) at S216. Beyond the spatial and temporal modalities presented in the illustrative embodiment, infra, other modalities in x(t) might include the passenger e-card information, traveling preferences, the contextual information relevant to the city, etc.

To estimate the alighting probability in the contemplated embodiment, the spatial constraint wᵢⱼ and the temporal constraint dᵢⱼ are taken into account. The spatial constrint wᵢⱼ is defined herein as the walking time from a first stop aᵢⱼ to a second stop bᵢ₊₁. In certain embodiments, the spatial constraint can be computed using GTFS urban data. The temporal constraint dᵢⱼ is defined herein as the difference between the boarding time tᵢ₊₁^{b} and the alighting candidate time tᵢⱼ^{a} augmented with the walking time, represented by the equation: dᵢⱼ=(tᵢ₊₁^{b}−tᵢⱼ^{a}−αwᵢⱼ)₊, α ε [1 . . . 2],

The non-negativity of the temporal delay factor dᵢⱼ is used to exclude the unfeasible alighting candidates. The time-spatial relationship between alighting candidates aᵢ and the boarding b is modeled by the Guassian kernals. The spatial factor wᵢⱼ is used as a distance input and the temporal factor dᵢⱼ is used to control the spread of the Guassian using the equation:

$$k ( {a}_{ij} , {b}_{i + 1} ) = {e}^{\frac{{w}_{ij}}{2 {σ}^{2} {d}_{ij}^{2}}} \qquad ( 2 )$$

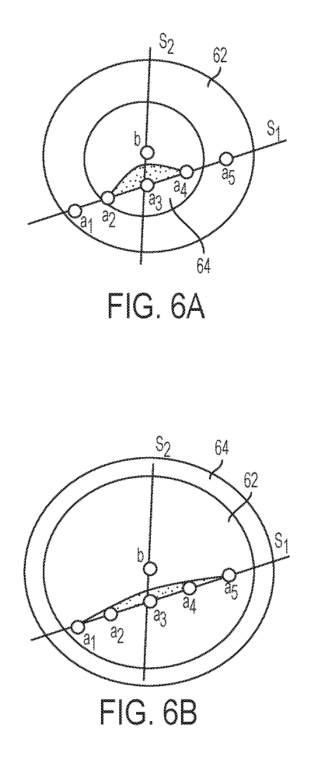

FIG. 6A shows an alighting probabilistic inference generated for a tight transfer from a first service s₁ to a second service s₂ with the boarding stop b at the timestamp t_{b}. The transportation network or route map is omitted for illustrative purposes. The first region 62 limits the walking zone to k minutes from stop b with five alighting candidates a₁, . . . , a₅. This first region 62 (shown as a circle) represents the spatial constraint. A second circle 64 describes the temporal constraint by the transit time. FIG. 6B shows the alighting probabilistic inference generated for a loose transfer from the first service to the second service. The transfer time in FIG. 6A is tight, thus reducing the candidate list and giving closer stops higher values. The transfer time is longer in FIG. 6B, thus smoothing the probabilities over all candidates with a wider spread.

Returning to FIG. 2, in the case of a uni-goal trip, the uni-goal trip (g=1) is applied to the equation p₁(t)≡p(g=1|x(t))=p(g=1|x₁, . . . , xₖ), and is considered against all other cases where g>1, g>1, p_{>1}(t)=1−p₁(t).

Assuming the independence between different modalities xᵢ, the Bayes formula can be applied to rewrite a select modality as a distribution using the equation:

$$p ( g = 1 \vert x ) = p ( g = 1 \vert {x}_{1} , … , {x}_{k} ) = \frac{p ( g = 1 )}{z} {\prod }_{i = 1}^{k} p ( {x}_{i} \vert g = 1 ) \qquad ( 2 )$$

The method is parametric. This means that the system knows the shape of each modality distribution. Moreover, the system assumes that each modality fits a Beta distribution p(xᵢ|g=1)=Beta(xᵢ; αᵢ, βᵢ), i=1, . . . , k, and therefore represented by the equation:

p(g=1|x)∝ p(g=1)πᵢ₌₁^{k} Beta(xᵢ; αᵢ, βᵢ) (3)

In statistics, the Beta distribution is a family of continuous probability distributions defined on the interval; two positive parameters α and β control the power function of the variable x and of its reflection (1−x). Probability density function for random variable x with a Beta distribution is represented with the equation:

$$Beta ( x ; α , β ) = \frac{1}{B ( α , β )} {{x}^{α - 1} ( 1 - x )}^{β - 1} , α , β > 1 \\ where B ( α , β ) = \frac{Γ ( α ) Γ ( β )}{Γ ( α + β )} . \qquad ( 4 )$$

With the features x=(x₁, . . . , xₖ) available for all trips, a Maximum Likelihood Estimation (MLE) is used to infer parameters (αᵢ, βᵢ), i=1, . . . , k of each modality distribution. Given the available trip features x(t), the MLE chooses the parameter values that makes the data most probable (i.e., maximizes the probability of obtaining the sample that has actually been observed).

In more specific detail, the trip ratio calculator 24 generates an empirical trip distribution for a given stop for a first modality. To generate this distribution, the system 100 introduces the measure of trip ratio at S218. In the illustrative embodiment, the trip ratio calculator 24 can describe each trip with a spatial modality. Where the historical data includes trip information including a sequence of known boardings bᵢ and alightings aᵢ, i=1, . . . , n, the trip ratio is computed as a measure of the distance D connecting the origin boarding stop b₁ to destination stop oₙ to the sum of leg distances

$$γ = \frac{D}{{\sum }_{i = 1}^{n} {D}_{i}} .$$

Interested in the geometric interpretation, the trip ratio calculator 24 approximates the ratio as a tangent and normalizes the corresponding angle in the range between [0,1] using the equation:

$${x}_{sp} = \frac{2}{π} arctan \frac{D}{{\sum }_{i = 1}^{n} {D}_{i} - D} \qquad ( 5 )$$

wherein xₛₚ measures how far the trip deviated from a theoretically direct connection from the origin o=b₁ to the destination d=oₙ.

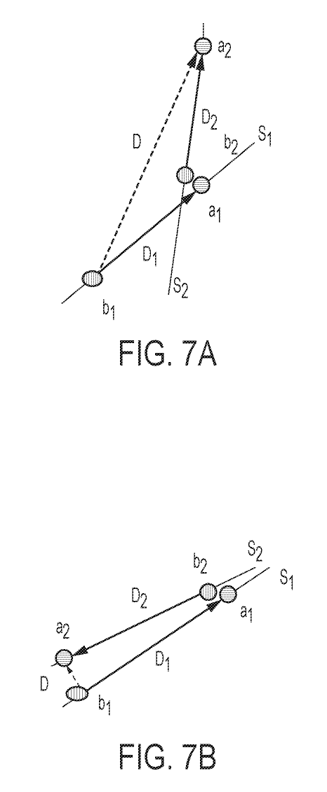

FIG. 7A shows an illustrative trip angle(s) for a sample uni-goal where a spatial modality is determined by measuring the trip ratio. The angle between an origin transit point and a destination is indicative of whether the passenger made at least one change. As shown in FIG. 7A, the ratio for a uni-goal trip is close to zero “0”. In a uni-goal trip, the passenger goes more or less in the same direction, so the angle would appear as shown in FIG. 7A. FIG. 7B shows an illustrative trip angle(s) for a sample multi-goal where the spatial modality is determined by measuring the trip ratio. As shown in FIG. 7B, the multi-goal trip is likely a round trip since the ratio trip is close to one “1”.

For a trip with a sequence of boardings bᵢ and estimated alightings Σ(ai) (previously computed at S214), the trip ratio is rather computed using the equation:

$${x}_{sp} = \frac{2}{π} arctan \frac{{\sum }_{i = 1}^{n} {𝔼}_{{a}_{ij} : {Σ}_{i}} {D}_{i}}{{𝔼}_{{a}_{n} : {Σ}_{n}} D} = \frac{2}{π} arctan \frac{{\sum }_{i = 1}^{n} {\sum }_{j} {p}_{ij} {D}_{ij}}{{\sum }_{j} {p}_{j} {D}_{j}} \qquad ( 6 )$$

wherein [symbol] ₐ_{ᵢⱼ}_{:Σ}_{ᵢ}Dᵢ is an estimation of the distance from the initial boarding stop to the sampled alightings, and D is the estimated trip distance which is a sum of all estimated trip legs from initial boarding point to the last alighting.

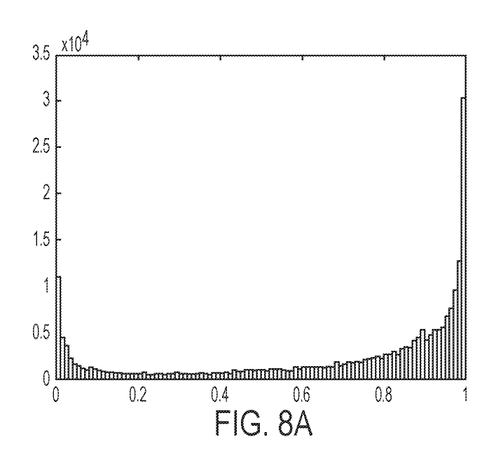

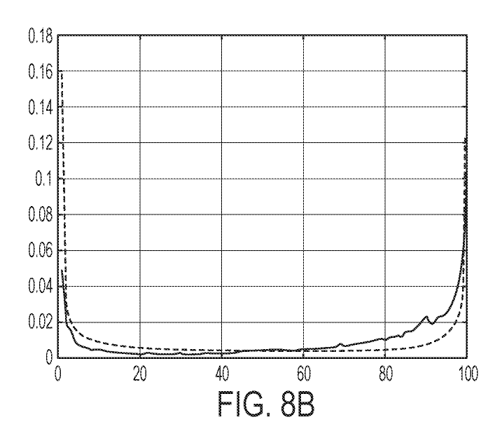

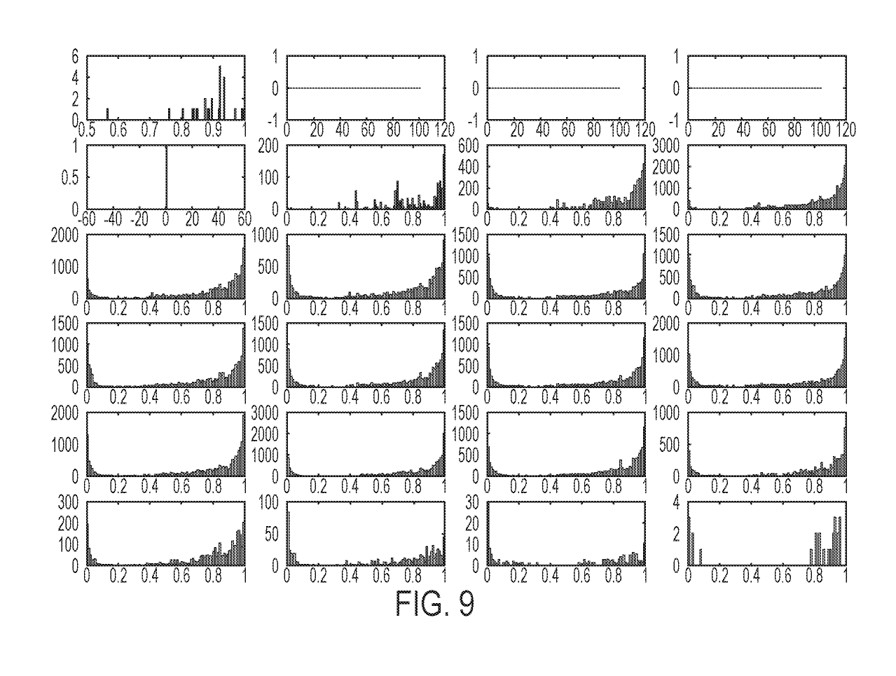

In one embodiment, the computed trip angles can be used to generate empirical distributions at S220. FIG. 8A shows an illustrative trip angle (empirical) distribution for trips taken in a transportation network. Returning to FIG. 2, the empirical angle ratio distribution is used to fit a Beta Distribution at S222. FIG. 8B shows an illustrative Beta distribution for the same trips also represented by the distribution of FIG. 8A. As FIGS. 8A-8B illustrate, the trip ratio values xₛₚ reflect the polarity observed in the historical trip data, where two modes essentially indicate that the trips with angle ratios close to zero “0” and one “1” dominate an empirical distribution. As mentioned, supra, the Maximum Likelihood Estimation was used to infer the parameters (α, β) of each modality distribution. In FIG. 8B, the Beta distribution is shown for the parameters α=0.26, β=0.24 computed for the illustrative dataset.

Returning to FIG. 2, at S224, with a sufficiently populated dataset, the angle ratio collection can be further segmented by time, such as, in one non-limiting example, by hours in a day. FIG. 9 shows the empirical trip angle distribution (similar to FIG. 8A, but) segmented by time in the unit of hours. Particularly, FIG. 9 shows the empirical trip angle distribution for a 24-hour period, starting at midnight and ending at 23:00 (11:00 pm). As FIG. 9 illustrates, the distributions for daytime hours (6:00-22:00, or 10:00 pm) fit well the Beta distribution shapes and present a clear uni- and multi-goal dichotomy. Fitting the Beta distribution will produce one pair of parameter values (αᵢ, βᵢ) per hour.

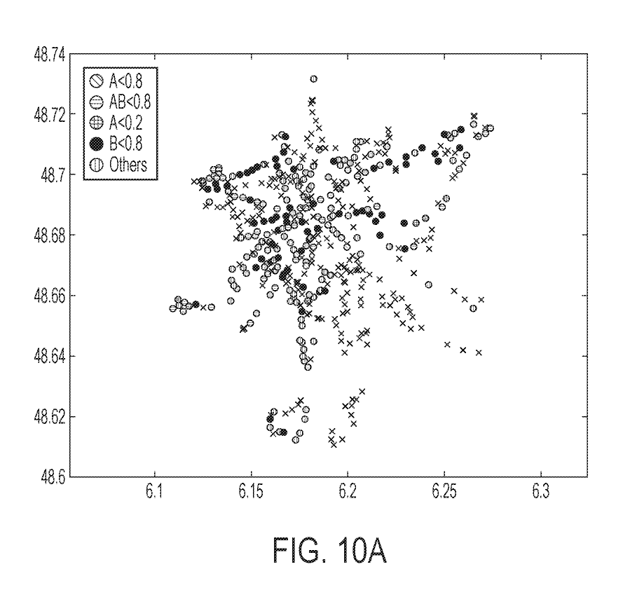

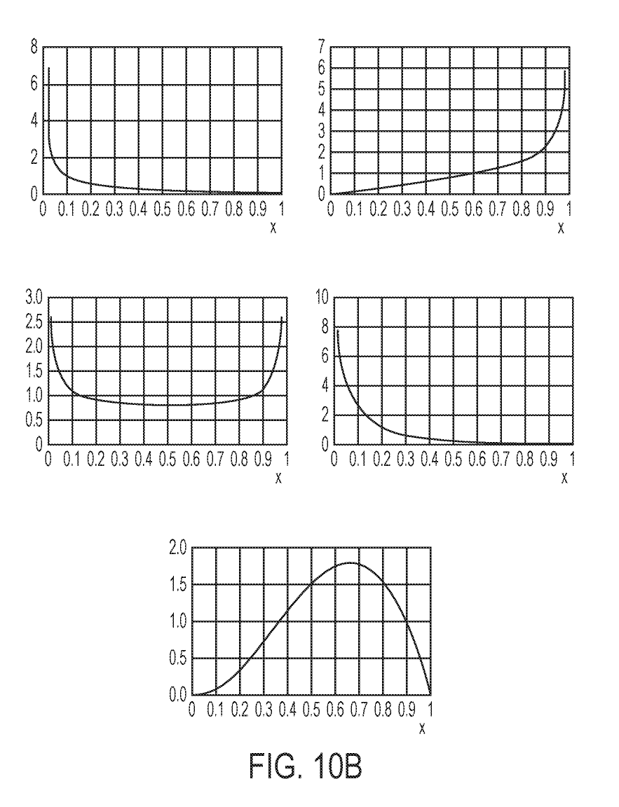

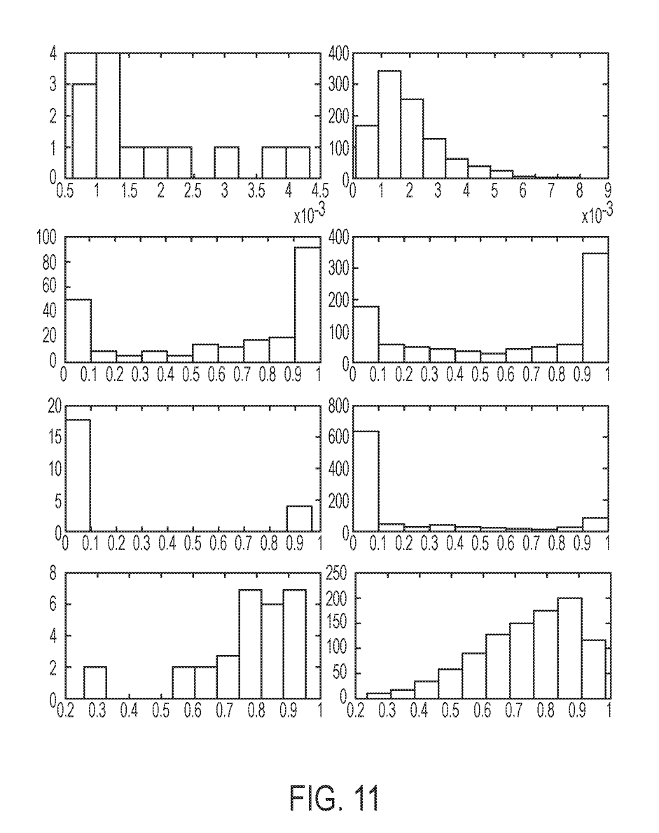

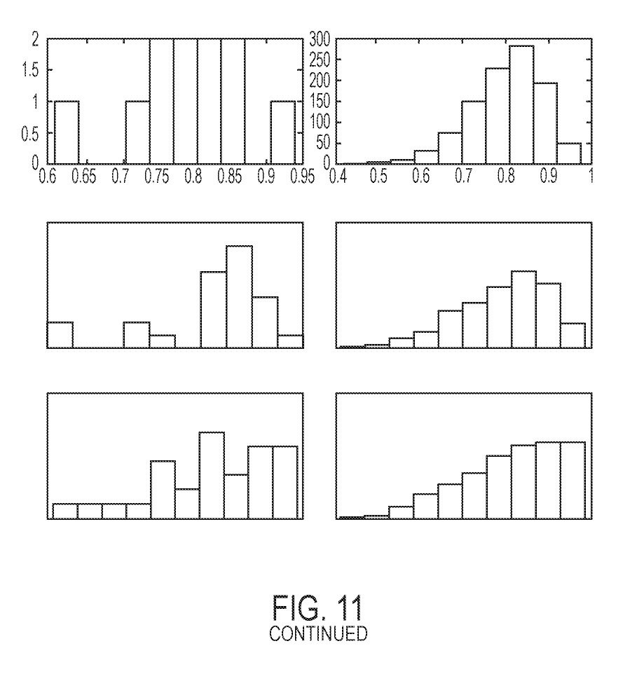

For the sake of visualization, the parameter values (αᵢ, βᵢ) can be also used to group stops by different shapes of the Beta distribution. FIG. 10A shows stops in a transportation network, which can be color coded (shown herein as different shades of black and gray) to each correspond with the shape of the different Beta distributions shown in FIG. 10B.

Returning to FIG. 2, parameters of a selected distribution are fitted to the given origin-destination stops at S226. Based on the detected distribution parameters, each trip estimated to include the given origin-destination stops is maintained or removed from the dataset at S228. The determination is made based on the fit. In one scenario disclosed herein for illustrative purposes, a user (possibly a transportation system) could receive the model for purposes of continuing or changing routes in the network. The user may desire to identify which stops to remove from its network to cut a budget. By looking at the distribution, such as the Beta, the user can identify a frequently used route at certain times of the day and continue to include that route in its network.

In summary, the algorithm disclosed below can be performed by the system to perform the method of parametric unsupervised learning and probabilistic annotation of trips as uni-goal ones. This output is then applied to the probabilistic inference of the ODT matrices. It estimates the uni-goal probability P₁=p(g=1|x) for any trip t. The trip is then stored in ODT as the uni-goal trip with probability P₁ and as multi-goal (aka, decomposed in the legs) with probability 1−P₁.

Algorithm 2 Probabilistic ODT assignment.

Require: Set of trips

[symbol]

| | {Fit Beta distribution with all trip modalities} |
|---|---|
| 1: | [symbol] := |
| 2: | for each t ε [symbol] do |
| 3: | Extract x(t) := (x₁ = xₛₚ, x₂ = xₜₑ, . . . , xₖ) |
| 4: | [symbol] := [symbol] ∪ x(t) |
| 5: | end for |
| 6: | (αᵢ, βᵢ) = FitBetaDistribution( [symbol] (:, i)) |
| | {Infer ODT with the uni-goal and multi-goal probabilities} |
| 7: | ODT = |
| 8: | for each trip t ε [symbol] do |
| 9: | $Set {P}_{1} := \frac{p ( g = 1 )}{Z} {\prod }_{i = 1}^{k} Beta ( {x}_{i} ; {α}_{i} , {β}_{i} )$ |
| 10: | Add to ODT entire trip t with probability P₁ |
| 11: | Add to ODT all trip legs lᵢ, i = 1, . . . , n with probability 1 − P₁ |
| 12: | end for |
| 13: | return ODT |

Returning to FIG. 2, the method ends at S230.

The method illustrated in FIGS. 2 and 4 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 22, (for example, an internal hard drive of RAM), or may be separate (for example, an external hard drive operatively connected with the computer 20), or may be separate and accessed via a digital data network such as a local area network (LAN) or the Internet (for example, as a redundant array of inexpensive or independent disks (RAID) or other network server storage that is indirectly accessed by the computer 22, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 2, can be used to implement the method. As will be appreciated, while the steps of the method may be computer implemented, in some embodiments one or more of the steps may be at least partially performed manually. As will also be appreciated, the steps of the method need not all proceed in the order illustrated and fewer, more, or different steps may be performed.

Although the control method is illustrated and described above in the form of a series of acts or events, it will be appreciated that the various methods or processes of the present disclosure are not limited by the illustrated ordering of such acts or events. In this regard, except as specifically provided hereinafter, some acts or events may occur in different order and/or concurrently with other acts or events apart from those illustrated and described herein in accordance with the disclosure. It is further noted that not all illustrated steps may be required to implement a process or method in accordance with the present disclosure, and one or more such acts may be combined. The illustrated methods and other methods of the disclosure may be implemented in hardware, software, or combinations thereof, in order to provide the control functionality described herein, and may be employed in any system including but not limited to the above illustrated system 100, wherein the disclosure is not limited to the specific applications and embodiments illustrated and described herein.

One aspect of the present disclosure is two approaches to reduce uncertainty. The disclosed system and method first eliminate sources of uncertainty that are not critical for simulations, particularly by grouping stops which have equivalent travel offers and capacities. By grouping stops by equivalence, the disclosed system and method can generate denser data for improved analysis and prediction. Furthermore, grouping stops by equivalence reduces the variable space, enabling faster processing and calculations. The disclosed system and method also provides a parametric approach for distinguishing so called “one-goal” trips from other trips.

Another aspect of the present disclosure is a system and method that approximates travel demand with Beta distribution parameters for generating simulated trips and fits Beta distribution values for the entire network.

Another aspect of the present disclosure is an approach for simulating transportation networks where the transaction data only includes boarding validation systems, particularly by disclosing a probabilistic treatment of alighting uncertainty.

### EXAMPLE 1

The disclosed method was tested on seven individual transit (o,d) pairs in a transporation network dataset. FIG. 11 shows an empirical trip angle distribution (top row) and a Beta distribution (bottom row) for the example dataset. Specifically, the

FIG. 9 shows (upper row) the empirical angle ratio distribution for seven different (o, d) pairs in Nancy dataset. Once they were used to fit the Beta distribution, the low row shows the PDF (probability distribution functions) with the corresponding (αᵢ, βᵢ) parameters.

Regarding the temporal modality, multiple transit trips exposed unexpectedly long transit times between public transportation services. These trips were likely multi-goal that cannot be properly modeled by a conventional trip planner. The temporal modality xₜₑ of a trip was introduced and parametrized as a Beta distribution. Any transfer during a trip was treated as a function of the distance between the stops, walking speed, vehicle (such as, bus) arrival sequence and the waiting time. The expectation of the waiting time was computed over the alighting distribution using the equation xₜₑ=

$$\frac{1}{n} {\sum }_{i = 1}^{n} {𝔼}_{{a}_{ij} : {Σ}_{i}} {d}_{ij} .$$

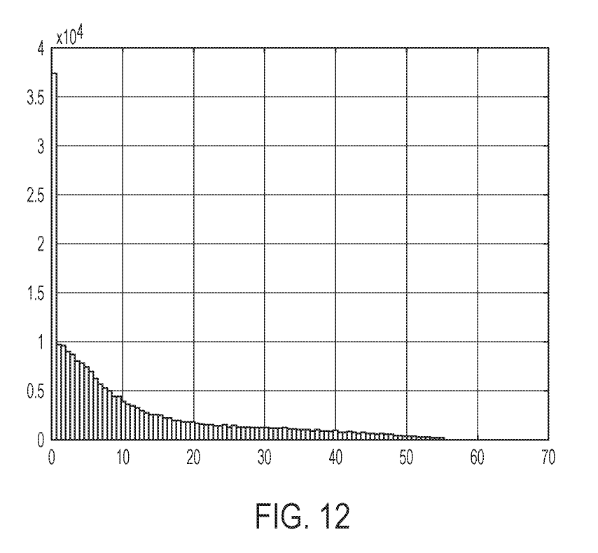

FIG. 12 shows the empirical trip angle distribution of the expected waiting time in the example dataset. Less polarizing than the spatial modality, it still contributes to the detection of multi-goal trips.

### EXAMPLE 2

The disclosed method was tested on dataset including 224,000 trips collected from a transporation network during a period of 3 months in 2012. The public transport system offered 27 bus and tram schedule-based services running along 89 different routes, and accounting for a total of 1129 stops. For the purpose of the example, only the datasets collected on workdays was evaluated. Trip data collected on holidays (vacation) and weekends was excluded.

The uncertainty measure was used to test different methods on the capacity to model the travel demand in the urban mobility context. Table 1 reports uncertainty measures when testing different combinations of methods described in the previous sections:

TABLE 1
Uncertainty values for diff methods.

| Method | Min | Max | Average |
|---|---|---|---|
| Raw | 0.98 | 4.61 | 2.39 |
| SE | 0.97 | 4.34 | 1.97 |
| SE + SBeta | 0.97 | 4.03 | 1.78 |
| SE + TBeta | 0.97 | 4.34 | 1.95 |
| SE + SBeta + TBeta | 0.97 | 4.00 | 1.72 |

wherein “Raw” means that raw data was used; “SE” means that stop equivalence classes were used to reduce the network size; “SBeta” means that a spatial Beta distribution fit was used; and “TBeta” means that a temporal Beta distribution fit was used.

The uncertainty measure has an indicative character only; it measures the entropy level of the system. Table 1 shows how different combinations reduce this uncertainty.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for estimating travel demand in a transportation network, the method comprising:
receiving a dataset of trips taken in the transportation network each represented by an origin-destination pair and a departure time, wherein a trip can include a sequence of legs;
describing each trip by a vector of modalities;
for trips that include the sequence of legs, estimating boarding and alighting stops;
generating an empirical trip distribution for each modality for given origin-destination stops; and
fitting the empirical trip distribution to a specific family of probability distributions;
wherein at least one of the generating the empirical trip distribution for a given modality and fitting the empirical trip distribution to the probability distributions is performed with a processor.

2. The method of claim 1, wherein the modalities are each selected from a group consisting of: spatial, temporal, personal, and a combination of the above.

3. The method of claim 2 further comprising:
determining the spatial modality by measuring a trip ratio of a distance connecting the origin to the destination to a sum of leg distances for each trip.

4. The method of claim 3, wherein the measuring the trip ratio includes:
in response to the trip being a roundtrip, computing the ratio as an arctangent using the equation:
$${x}_{sp} = \frac{2}{π} {tan}^{- 1} \frac{D}{{\sum }_{i = 1}^{n} {D}_{i} - D}$$
wherein D is a distance connecting an origin to a destination stop; and
in response to the trip including the sequence of legs, computing the ratio as the arctangent using the equation:
$${x}_{sp} = \frac{2}{π} arctan \frac{{\sum }_{i = 1}^{n} {𝔼}_{{a}_{ij} : {Σ}_{i}} {D}_{i}}{{𝔼}_{{a}_{n} : {Σ}_{n}} D} = \frac{2}{π} arctan \frac{{\sum }_{i = 1}^{n} {\sum }_{j} {p}_{ij} {D}_{ij}}{{\sum }_{f} {p}_{j} {D}_{j}}$$
wherein [symbol] ₐ_{ᵢⱼ}_{:Σ}_{ᵢ}Dᵢ is an estimation of the distance from an initial boarding stop to each of the alighting stops, and D is an estimated sum of all legs of the trip from an initial boarding stop to a last alighting stop.

5. The method of claim 2 further comprising:
determining the temporal modality by measuring delays in transfer time of between the trip legs for each trip.

6. The method of claim 1, wherein the specific family of probability distributions includes a Beta distribution.

7. The method of claim 1 further comprising:
identifying all origin-destination stops pairs in the transportation network;
grouping multiple origin-destination stop pairs in a cluster, by closeness of origin stops, destination stops or both;
merging empirical distributions for stop pairs in each cluster, for each modality;
fitting the distribution parameters and maintaining one parameter set for each cluster of origin-destination stop pairs.

8. The method of claim 7, wherein the grouping the multiple origin-destination stop pairs in the cluster includes:
identifying an equivalence relationship between neighboring stops in the transportation network, wherein the equivalence is determined by a set of change points achievable from the stops.

9. The method of claim 7, wherein the merging the empirical distributions includes:
generating a set of equivalence pairs forming oriented arcs in a stop graph; and
applying a transitivity property to the equivalence pairs to obtain the equivalence classes.

10. The method of claim 6, wherein the transitivity property includes a Floyd-Warshall algorithm.

11. The method of claim 1 further comprising:
measuring uncertainty of one trip over another trip in the transportation network using a Kullback-Leibler divergence of the empirical trip distribution from a uniform trip distribution.

12. The method of claim 8, wherein the measuring the uncertainty includes:
plotting divergence values for the origin-destination pairs in the transportation network using a log-log scale, wherein a Kullback-Leibler value is inversely proportional to a level of uncertainty and is directly proportional to a strength that the one trip dominates over the other trip.

13. The method of claim 1 further comprising:
fitting parameters of a selected distribution corresponding to the given origin-destination stop pair;
based on the detected distribution parameters, maintaining or removing from the dataset the each trip estimated to include the given origin-destination stop pair.

14. A system for estimating travel demand in a transportation network, the system comprising:
a computer programmed to perform a method for estimating the travel demand and including the operations of:
receiving a dataset of trips taken in the transportation network each represented by an origin-destination pair and a departure time, wherein a trip can include a sequence of legs;
describing each trip by a vector of modalities;
for trips that include the sequence of legs, estimating boarding and alighting stops;
generating an empirical trip distribution for each modality for given origin-destination stops; and
fitting the empirical trip distribution to a specific family of probability distributions.

15. The system of claim 14, wherein the computer is further programmed to perform the operation of:
determining a spatial modality by measuring a trip ratio of a distance connecting the origin to the destination to a sum of leg distances for each trip.

16. The system of claim 15, wherein the measuring the trip ratio includes:
in response to the trip being a roundtrip, computing the ratio as an arctangent using the equation:
$${x}_{sp} = \frac{2}{π} {tan}^{- 1} \frac{D}{{\sum }_{i = 1}^{n} {D}_{i} - D}$$
wherein D is a distance connecting an origin to a destination stop; and
in response to the trip including the sequence of legs, computing the ratio as the arctangent using the equation:
$${x}_{sp} = \frac{2}{π} arctan \frac{{\sum }_{i = 1}^{n} {𝔼}_{{a}_{ij} : {Σ}_{i}} {D}_{i}}{{𝔼}_{{a}_{n : {Σ}_{n}}} D} = \frac{2}{π} arctan \frac{{\sum }_{i = 1}^{n} {\sum }_{j} {p}_{ij} {D}_{ij}}{{\sum }_{j} {p}_{j} {D}_{j}}$$
wherein [symbol] ₐ_{ᵢⱼ}_{:Σ}_{ᵢ}Dᵢ is an estimation of the distance from an initial boarding stop to each of the alighting stops, and D is an estimated sum of all legs of the trip from an initial boarding stop to a last alighting stop.

17. The system of claim 14, wherein the computer is further programmed to perform the operation of:
determining a temporal modality by measuring delays in transfer time of between the trip legs for each trip.

18. The system of claim 14, wherein the specific family of probability distributions includes a Beta distribution.

19. The system of claim 14, wherein the computer is further programmed to perform the operation of:
identifying all origin-destination stop pairs in the transportation network;
grouping multiple origin-destination stop pairs in a cluster, by closeness of origin stops, destination stops or both;
merging empirical distributions for stops pairs in each cluster, for each modality;
fitting the distribution parameters and maintaining one parameter set for each cluster of origin-destination stop pairs.

20. The method of claim 4, wherein the grouping the multiple origin-destination stop pairs includes:
identifying an equivalence relationship between neighboring stops in the transportation network, wherein the equivalence is determined by a set of change points achievable from the stops.

21. The system of claim 15, wherein the computer is further programmed to perform the operation of:
fitting parameters of a selected distribution corresponding to the given origin-destination stop pair;
based on the detected distribution parameters, maintaining or removing from the dataset the each trip estimated to include the given origin-destination stop pair.
